(19) United States
(12) Patent Application Publication
(10) Pub. No.: US 2007/0094136 A1
(43) Pub. Date: Apr. 26, 2007

(54) Method of selecting line item kind for invoice database

(76) Inventors: Robert Reiner, Sandhausen (DE); Benjamin Klehr, Rastatt (DE); Andrei Jadanovski, Schwabisch Hall (DE); Hua Wang, Mannheim (DE); Paola Sala, Heidelberg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/255,973

(22) Filed: Oct. 24, 2005

(51) Int. Cl. G06Q 40/00

(52) U.S. Cl. 705/40

(57) ABSTRACT

Systems and methods are disclosed for providing an interface on a user display by a computer system, which enables the user to input, view, and interact with an invoice. The invoice may include one or more line items, each having one or more item attributes. One of the item attributes may be an item kind attribute. The item kind attribute may indicate the line item as an initial invoice item, a subsequent credit item, a subsequent debit item, a credit memo item, or any other suitable type of line item. A mechanism, such as a drop down menu, may be provided on the interface to enable the user to select an appropriate item kind.

### FIELD OF THE INVENTION

The present invention relates generally to a system and method for allowing a user to create, view, and interact with an invoice in a computer system, where the invoice has one or more line items of different item kinds.

### BACKGROUND INFORMATION

Invoicing is an important if not indispensable part of today's business transactions. Generally speaking, an invoice is a commercial document issued by one business partner to another, evidencing a transaction in which terms such as the products or services, their quantities, and agreed prices are indicated. The issuance of the invoice from one business partner to another signifies that payment is due from the partner receiving the invoice to the partner posting the invoice according to the agreed terms of the invoice. It is typical for the invoice to also include references to prior documents, such as purchase orders, goods receipt, and other documents that have been produced in connection with the business transaction.

Typically, an invoice may not be modified once it has been issued. However, it is entirely foreseeable that some changes may need to be made to the terms of an issued invoice, for example, due to mistakes made during issuance of the invoice, due to subsequent related business transactions, or due to any other suitable conditions. As an example, when a buyer returns products that it has purchased for a refund, the value in the issued invoice for the initial delivery of products is no longer current. Since the issued invoice is not to be modified, another document, which is often known as a credit memo is created to document and resolve the refund. The credit memo includes terms that are similar to the issued invoice, for example, it may refer to the same purchase order, and reflect the refund to the buyer. As another example, the price quoted in the initial invoice may differ from an actual price that is to be paid for some or all of the products in the invoice, for example, due to a mistake in pricing or a subsequent discount. In this situation, a new document such as a subsequent credit or subsequent debit may be created to reflect the changed price and value.

While documents such as credit memo, subsequent credit, subsequent debit, and any other such invoice-related documents, are essentially stand-alone documents evidencing debit or credit, they remain supplements to an existing invoice and thus, may not be created prior to the creation of the initial invoice. Some checks are generally performed on the subsequent documents against the initial invoice to ensure that no conflicts arise. For example, a general rule governing subsequent documents, such as subsequent credit/debit and credit memo, is that the quantities of the items listed in the subsequent documents may not exceed those of the corresponding items listed in the initial invoice.

In the traditional paper-based invoicing schemes, invoices and their related subsequent documents are individual documents kept in files. Verification of the subsequent documents against the invoice must be performed manually. This process is time-consuming and error-prone. Computer systems and software applications have been developed in an attempt to at least partially automate the invoicing process. However, the procedures for invoicing in these computer systems are generally designed based on the paper-based paradigm and thus, not fully realizing the advantages and capabilities of such systems and applications. For example, many computer systems and applications continue to provide one method of generating subsequent documents, which is to generate them independently of the invoice. Checks may be performed, for example, upon saving the subsequent document, to ensure that the terms of the subsequent document correspond to and do not conflict with those terms of the invoice according to the various rules for creating subsequent documents. This process includes a lot of redundancy and opportunities for error.

Thus, it would be advantageous to provide an improved method and system for creating a comprehensive invoice in a computer system that includes a plurality of line items, where the line items may include invoice items, as well as subsequent items, such as credit memo items, subsequent credit items, subsequent debit items, and any other suitable line items. It would also be advantageous to provide in such a computer system an interface in which the user may input the invoice, including the plurality of line items. The inputting of the line items may include allowing the user to select appropriate line item kinds, such as credit memo, subsequent credit/debit, etc. for the line items.

### SUMMARY OF THE INVENTION

Consistent with the principles of the present invention, systems and methods are disclosed for allowing a user to create, view, and interact with an invoice having one or more line items, which are associated with different item kinds, in a computer system.

In accordance with a system consistent with the principles of the present invention, the computer system may provide an interface on a user display that enables the user to input, view and interact with an invoice. The invoice displayed on the interface may include a number of general invoice attributes as well as one or more line items. The general invoice attributes may include, for example, references to other related documents such as purchase orders, goods receipts, etc., information on vendors, invoicing parties, currencies, and any other suitable attributes associated with an invoice. Each of the one or more line items of the invoice may include its own set of line item attributes. These attributes may include descriptions of the line item, price of the line item, quantity of the line item, and any other suitable line item attribute.

In accordance with a system consistent with the principles of the present invention, a line item may additionally include an item kind attribute. Consistent with the principles of the present invention, the item kind attribute may indicate the line item as an invoice item, a subsequent credit item, a subsequent debit item, a credit memo item, or any other suitable type of item. In order to enable the user to enter or otherwise select such an item kind for a particular line item, the system may provide, for example, a mechanism on an interface that allows the user to select or otherwise input an item kind for a particular line item. As an example, the user may select the item kind from a plurality of item kinds displayed, for example, in a drop down menu or any other suitable mechanism.

The user may initiate saving of the invoice when satisfied with the invoice entry. In response to the user initiating saving of the invoice entry, the system may perform various checks, for example, in accordance with various rules governing appropriate invoice entry. Notably, if the invoice includes line items that are of different invoice item kinds, the system may check the various line items, for example, in combination and against each other to ensure that the totality of these line items accurately reflects the business transactions. As an example, the quantities of various subsequent items, such as subsequent credit/debit items, credit memo items, etc., may be checked to make sure that they do not exceed the quantity of any corresponding initial invoice items. If failure occurs during the checking process, the system may prevent saving of the invoice entry and may alert and/or require the user to fix the problem before proceeding. If no failure occurs during the checking process, the invoice entry may be posted and transferred to an appropriate backend processing system, such as SAP's R/3 Fl system for further processing.

It is to be understood that both the foregoing general description and the following detailed description are exemplary and explanatory only and are not restrictive of the invention as claimed. The foregoing background and summary are not intended to provide any independent limitations on the claimed invention.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a flow chart of illustrative stages involved in performing general invoice verification in accordance with a system consistent with the principles of the present invention.

FIG. 2 is a flow chart of illustrative stages involved in inputting subsequent items in connection with an existing invoice in accordance with a system consistent with the principles of the present invention.

FIG. 3 is an exemplary invoice entry screen in which a line item overview window is displayed in accordance with a system consistent with the principles of the present invention.

FIG. 4 is an exemplary invoice entry screen in which an item entry window is displayed in accordance with a system consistent with the principles of the present invention.

FIG. 5 is an exemplary invoice entry screen in which a line item overview window showing item kind attributes is displayed in accordance with a system consistent with the principles of the present invention.

FIG. 6 is a flow chart of illustrative stages involved in providing an interface for allowing a user to input an invoice having one or more line items with different item kind attributes in accordance with a system consistent with the principles of the present invention.

FIG. 7 illustrates a computer system for implementing a software application in accordance with a system consistent with the principles of the present invention.

FIG. 8 illustrates another computer system for implementing a software application in accordance with a system consistent with the principles of the present invention.

### DETAILED DESCRIPTION

The following detailed description refers to the accompanying drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

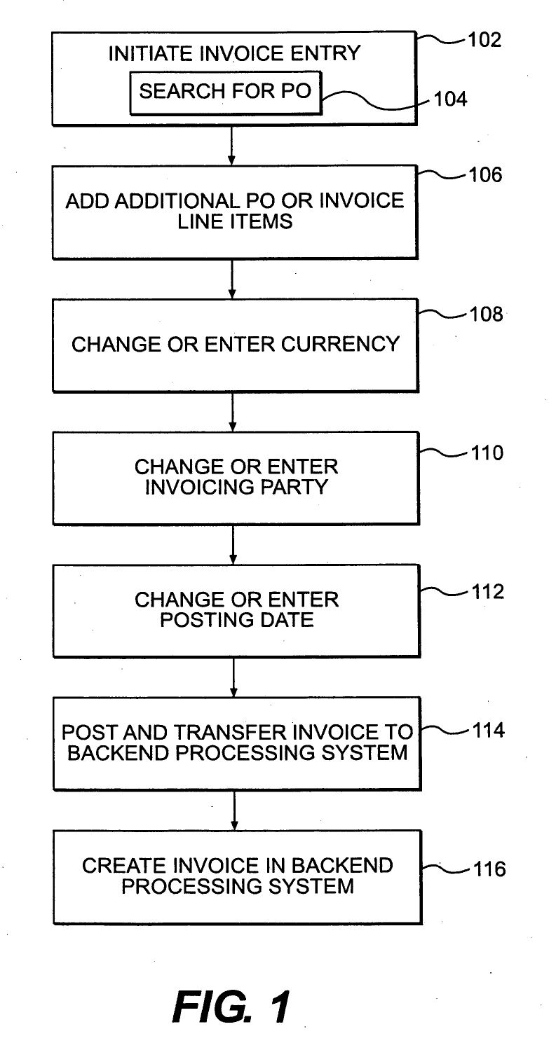

FIG. 1 shows a flow chart of illustrative stages involved in creating and verifying an invoice in accordance with a system consistent with the principles of the present invention. It should be understood that FIG. 1 is merely illustrative of some of the possible stages that may be involved in an invoice verification process. Stages may be skipped or added and the order of the stages may be modified without departing from the spirit of the present invention.

At stage 102, a user initiates the entry of a new invoice into a computer system, for example, in response to receiving a paper or electronic invoice, or in response to any other suitable invoicing event. Because an invoice is often issued in connection with one or more prior purchase orders, which may be previously saved and accessible by the computer system, the user may initiate, at stage 104, a search for such one or more purchase orders and/or other related documents. As an example, the user may search for a related purchase order using a purchase order number, a vendor name, or any other suitable search criterion or set of criteria. Consistent with the principles of the present invention, the search for purchase orders and/or other related documents may also be automatic, for example, in response to the user entering a purchase order number or in response to any other suitable events.

Once one or more related purchase orders and/or other related documents are found, the data associated with the purchase orders and/or documents may be automatically used to fill in at least some of the required fields of the invoice. The user may be allowed to later modify these automatically filed-in fields. If no purchase orders and/or other appropriate documents are found or if the user does not request search of such purchase orders or documents, the user may simply input all the invoice data. Some of the possible inputs and/or modifications are discussed in connection with the illustrative stages below.

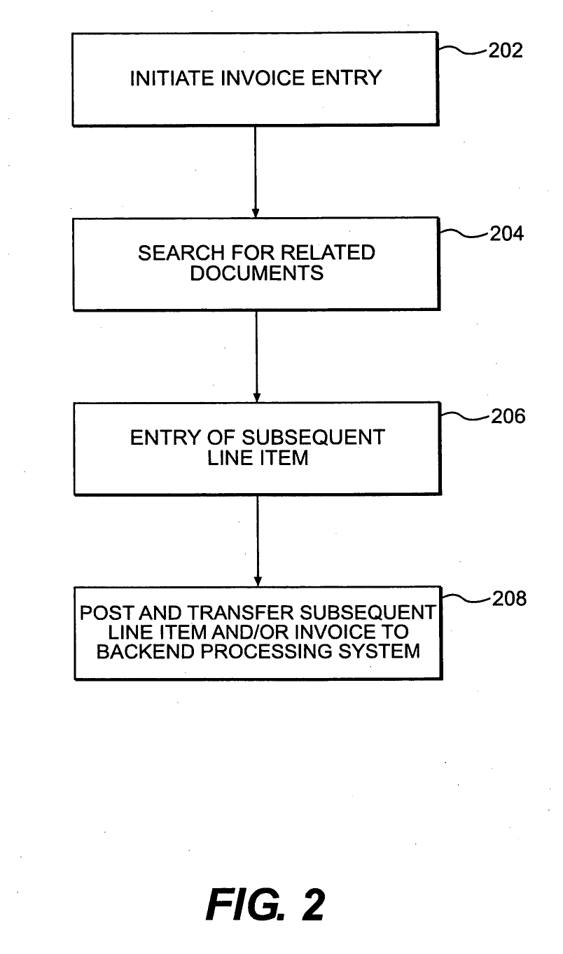

For example, at stage 106, the user may input purchase orders in addition to those resulted from the search of stage 104. Data from a purchase order that became associated with the invoice entry at stage 104 and 106 may include various line items. The line item may be a specific product and its associated invoicing information, such as price and quantity, or any other suitable line item information. The user may also input, at stage 106, line items that are not, for example, derived from a purchase order. For example, line items that are of item kind subsequent credit/debit, credit memo, or any other suitable item kind, which may not be associated with a purchase order, may be added. Addition of these subsequent line items will be described in more details in connection with FIGS. 2, 4, and 5 below.

If the invoicing is to be posted in a different currency from the currencies associated with, for example, the one or more purchase orders, the user may change the currency of the invoice at stage 108. If no currency was suggested by the system, for example, based on prior purchase orders, the user may simply enter the currency for the invoice at stage 108.

At stage 110, the invoicing party, from whom the invoice originated, may be changed or inputted. A change of invoicing party from the one suggested by the system may be due to the fact that the system suggested invoicing party is the vendor who had provided the products, while the invoicing party designated on the received invoice is a party assigned by the vendor specifically to perform its invoicing. Again, if no invoicing party was suggested by the system, the user may enter the invoicing party at stage 110. Similarly, at stage 112, the date for posting the invoice to an appropriate financial system may be modified or inputted.

Once all the appropriate information that is required in an invoice entry are entered, the invoice may be posted and transferred to a backend processing system at stage 114. Consistent with the principles of the present invention, the posting and transferring operation may include posting the invoice to a backend processing system, such as the SAP Resource Management System. Saving of the invoice may be performed, for example, in response to the user requesting that the invoice be posted from the invoice entry interface of the system. Various checks and verifications may be carried out by the system prior to saving and transferring of the invoice entry. As an example, the invoice may be checked for completeness. As another example, the various line items may be checked against each other to ensure that no conflict exists. This type of check is especially important when the invoice includes line items of different item kinds, including invoice item kind, subsequent credit/debit item kind, credit memo item kind, and any other suitable line item kinds. The checks performed in connection with such line item kinds will be described in more details below. Upon receiving the invoice entry at the backend processing system, an invoice appropriate for processing in the backend processing system may be created at stage 116.

FIG. 2 shows a flow chart of illustrative stages involved in entering, for example, subsequent credit/debit, credit memo, or any other suitable subsequent items in connection with an existing invoice in a system consistent with the principles of the present invention. In such a system, subsequent items, as referred to herein, may include various components including header level components, which may indicate the type of subsequent items such as credit memo, and item level components, which may indicate specific items such as a subsequent debit item. It should be understood that subsequent items may be defined in various suitable manners without departing from the spirit of the present invention. It should be understood that FIG. 2 is merely illustrative of some possible stages involved in entering subsequent line items in connection with an invoice. Some stages may be added, omitted, reordered, or modified in any other manner without exceeding the scope of the present invention.

As mentioned above, an existing invoice, specifically its various line items, may not be modified substantially subsequent to the issuance of the invoice. One way to make adjustments to the representation of an existing line item of an invoice may be to create one or more subsequent line item to supplement the initial line item. In this way, when all the line items of the invoice, both initial and subsequent, are considered and calculated as a whole, the combined value and status of the invoice would be an accurate reflection of the corresponding business transactions. Accordingly, consistent with the principles of the present invention, user initiation of an entry for a subsequent credit/debit, credit memo, or any other suitable subsequent line item is essentially entry of a new line item to an existing invoice.

As briefly mentioned above in connection with FIG. 1, entry to an invoice may begin with the user initiating entry of an invoice, which is shown in stage 202. This stage may be the same or substantially similar to the initiation of a new invoice entry in stage 101 of FIG. 1. At stage 204, the system searches, automatically or in response to a user request, for documents that are associated with the new subsequent item entry. The system may initiate an automatic search, for example, when the user enters appropriate referencing information, such as a purchase order number, an invoice number, a vendor, an invoicing party, or any other suitable information. Alternatively, the user may request such a search based on one or more pieces of referencing information, such as those mentioned above in connection with the automatic search, once the user enters such information, which may be used as a criterion for the search.

In stage 204, any existing invoice, with its line items, for example, to which the new subsequent line item may correspond, may be identified. Stage 204 may also identify any purchase orders and/or other suitable reference documents. These documents may be substantially similar to those identified in stage 102 of FIG. 1. Once the appropriate invoices, purchase orders, and any other related documents, are found in stage 204, they may be used to automatically fill in some of the required fields in the currently initiated invoice entry.

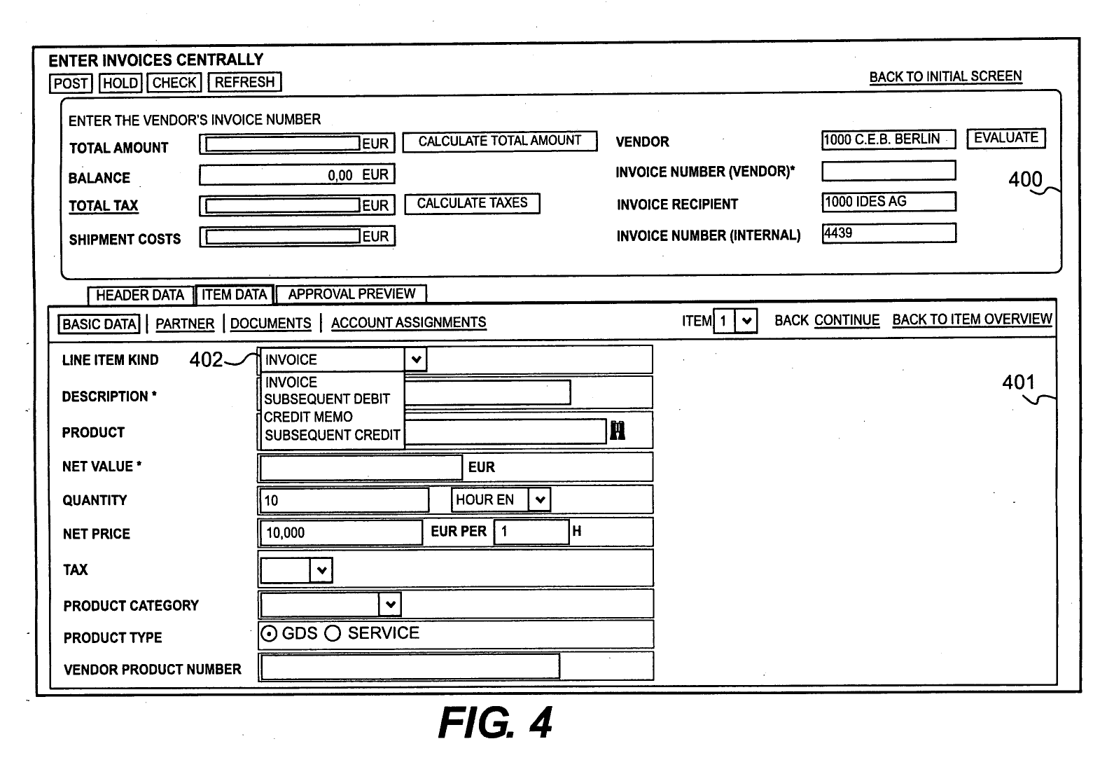

As mentioned above, the subsequent line item may be created, for example, as an additional line item entry to the list of invoice items in an appropriate existing invoice. An example of adding subsequent line item entries, such as subsequent credit/debit item, credit memo item, or any other suitable subsequent line item, is shown in FIG. 4, which will be discussed in more details below. In entry of subsequent line items at stage 206, it is important that the items be indicated as being subsequent, so as to allow differentiation from any existing invoice items. As an example, the interface for allowing entry of the subsequent line items may include a mechanism for enabling the user to indicate an appropriate item kind, including invoice item, subsequent credit item, subsequent debit item, credit memo item, and any other suitable item kind for each of the line item. One example of such a mechanism provided in an interface is shown in FIG. 4.

Once the user is satisfied with the addition of the one or more subsequent items to the invoice entry, the user may initiate saving the one or more subsequent items at stage 208. At this stage, the system may perform various checks, for example, in accordance with various rules governing the addition of subsequent items, prior to saving the one or more subsequent items. As an example, the system may check at stage 208 that the quantity of a subsequent item, regardless of it being a subsequent credit/debit, credit memo, or any other suitable subsequent item, does not exceed the quantity of any corresponding initial invoice item. As another example, the system may check that the combined value of all the line items, initial and subsequent, are within certain pre-set bounds. For example, the total value of all of the line items may be required to be non-negative. Any other suitable checks may be performed at this stage to ensure that the subsequent line items are appropriately entered and no conflicts arise among the various line items.

If failure occurs during the checking process, the system may prevent saving of the subsequent line items and may alert and/or require the user to fix the problem before proceeding. If no failure occurs during the checking process, the subsequent line item may be posted at stage 208. Saving of the subsequent line item may include transferring information on the subsequent line item and/or the invoice entry to an appropriate backend system, such as SAP's R/3 Fl system for further processing. Once the backend system receives the transferred subsequent line item and/or the invoice entry, it may update and existing invoice entry to which the subsequent line item is to be added, it may replace any corresponding existing invoice entry with the transferred invoice entry, or it may carry out any other suitable actions to ensure that the subsequent line item is properly associated with the appropriate corresponding invoice.

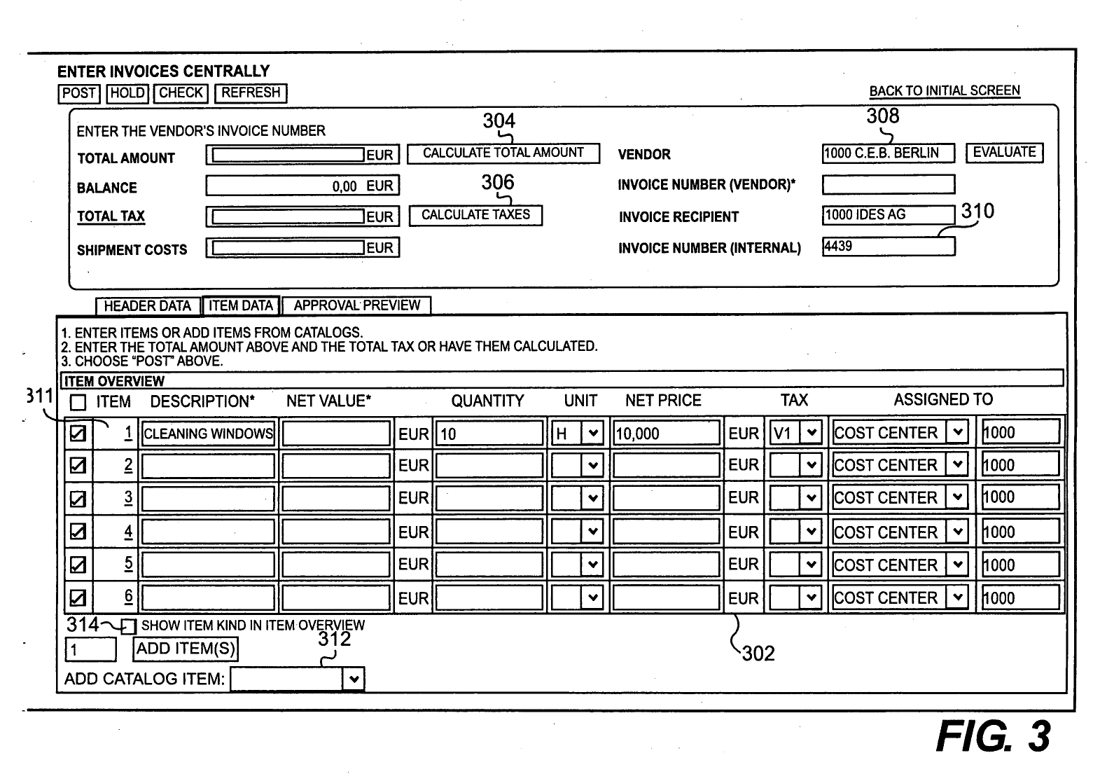

Some exemplary interface screens consistent with the principles of the present invention are shown in FIGS. 3-5. It will be understood that these screens are merely illustrative of the screens that may be used in connection with the present invention, and any other suitable screens may be used without departing from the spirit of the present invention.

FIG. 3 shows an exemplary new invoice entry screen 300 in accordance with a system consistent with the principles of the present invention. In this example, invoice summary or general information including, total invoice amount, total tax amount, vendor, invoice number, etc. may be entered, viewed, or modified in the top portion of the screen 300. Entry of some of these information into screen 300 may be either manual, for example, by a user, or automatic. As an example, consistent with the principles of the present invention, the user may request that the system calculate the total amount, for example, using information specific to the line items of the invoice, such as those show in lower portion 302 of screen 300. The user may make such a request, for example, using button 304. A similar request for calculating taxes may be placed using button 306. Some information of screen 300 may be automatically filled in based on, for example, corresponding information identified in a related purchase order or any other suitable related documents. Some information of screen 300, such as vendor 308, invoice recipient 310, and any other suitable information may be inactive, or otherwise made non-modifiable.

In portion 302 of screen 300, an overview of the various line items included in the invoice may be displayed. Some attributes or specifics to each of the line item, such as, for example, a description, a net value, quantity, net price, tax, etc. may be displayed. The user may add or modify items manually using the provided input means (e.g., text boxes and drop down menus). Alternatively, the user may choose to add an item and its associated data from a stored catalog by, for example, selecting the item from catalog 312.

As a line item may include many more attributes than those displayed in the item overview, a system consistent with the principles of the present invention may enable the user to access additional and more detailed item data for some or all of the items displayed in item overview. The user may access such detailed data of a selected line item, for example, by selecting its corresponding item number, such as item number 311, or any other suitable item attribute displayed in item overview. In response to the user selecting a line item to view, a screen such as screen 400 of FIG. 4 may be displayed.

The top portion of screen 400, in which general or summary invoice information are displayed, may be the same or substantially similar to that of screen 300. The bottom portion 401 of screen 400, approximately where the item overview 302 was displayed in screen 300, may now show specific line item data associated with the user-selected item. Item specific information, such as tax, product category, vendor product, and any other suitable line item attributes, which were not shown in the item overview, may now be displayed. The user may view, input, and modify these data in the appropriate spaces provided.

Consistent with the principles of the present invention, a line item kind attribute 402 may be specified by the user in window 401 of screen 400. The line item kind 402 may indicate the line item as an invoice item, a subsequent debit item, a credit memo item, a subsequent credit item, or any other suitable kind of line item. In this way, the user may include subsequent items in an existing invoice without reproducing the entire invoice. Also in this way, the various kinds of line items may be checked against each other and evaluated in combination in connection with a single invoice.

Consistent with the principles of the present invention, the line item kinds, for example, as inputted or selected in screen 400, may be made available in the item overview window, for example, item overview window 302 of FIG. 3, as a display attribute. As an example, in window 302, an option 314 may be provided to allow the user to request the inclusion of item kind attributes in item overview. Consistent with the principles of the present invention, option 314 may be provided only when it is determined that the invoice entry is associated with items having more than one item kind. For example, option 314 may only be made available in response to a user inputting two separate line items having two different line item kinds in the invoice entry using, for example, basic data form 401 of screen 400. Alternatively, the item kind attribute may be automatically provided in the item overview at all times or as soon as two items having different item kinds are entered.

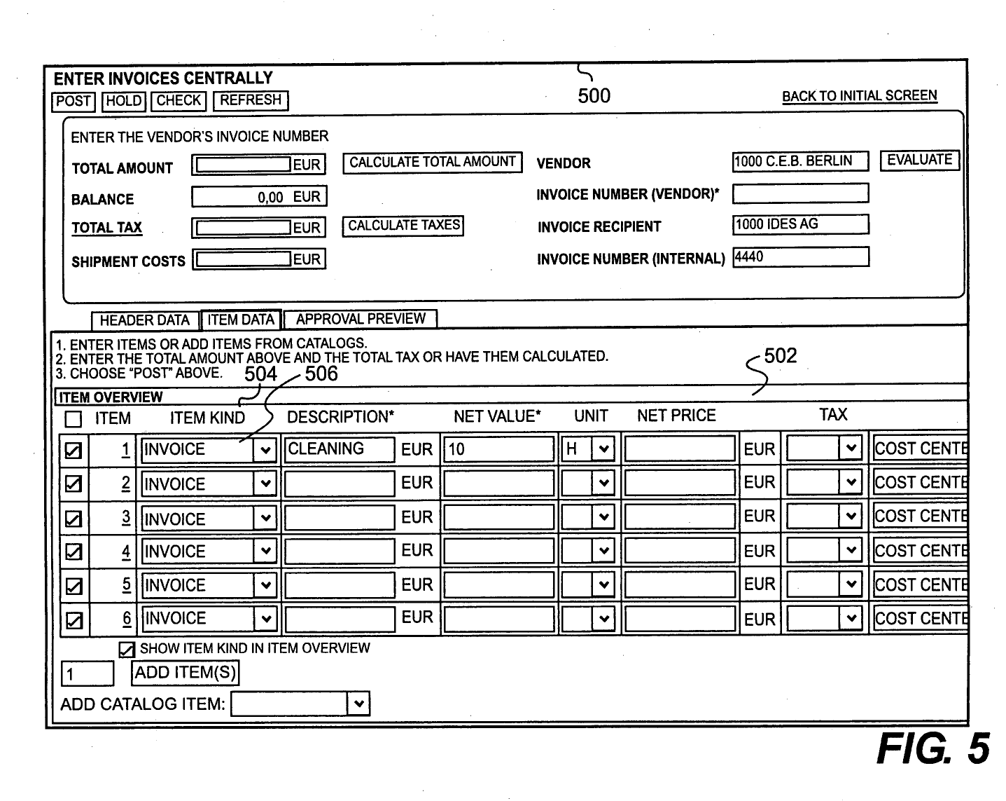

FIG. 5 shows an exemplary screen 500 having such an item overview window 502 in which item kind is displayed as attribute 504. The user may input or modify item kind attribute 504, for example, by selecting the appropriate item kind such as invoice, subsequent credit, subsequent debit, credit memo, etc. from drop down menu 506. Consistent with the principles of the present invention, item kind attribute 504 may be made active or inactive, thereby restricting modification of item kind of certain items, for example, in accordance with various rules. As an example, the first line item in item overview may have an inactive or non-modifiable item kind attribute, which may be restricted to item kind invoice only. This may insure that at least one line item entered in the invoice entry is a line item of item kind invoice. Many other suitable rules or restrictions on item kind may be implemented without departing from the spirit of the present invention.

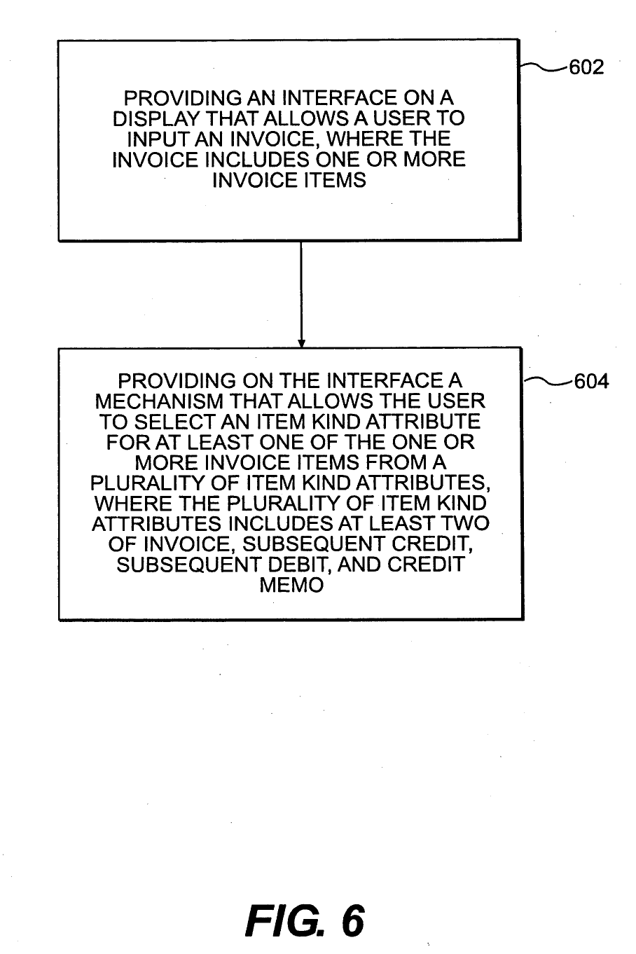

FIG. 6 shows a flow chart of illustrative stages involved in creating a subsequent line item in an invoice a system consistent with the principles of the present invention. At stage 602, an interface may be provided by the computer system, for example, on a user display, which enables the user to input an invoice. Examples of such an interface are shown in FIGS. 3-5. The invoice entry may include a number of general or summary invoice attributes as well as one or more invoice items. The general invoice attributes may include, for example, references to other documents such as purchase orders, goods receipts, etc., information on vendors, invoicing parties, currencies, and any other suitable attributes associated with an invoice. Each of the one or more line items of the invoice may include its own set of attributes. These attributes may include descriptions of the invoice item, the price of the item, the quantity of the item, and any other suitable line item attribute.

Consistent with the principles of the present invention, an invoice item may additionally include an item kind attribute. The item kind attribute may indicate a type for the line item. In some systems consistent with the principles of the present invention, the item kind attribute may indicate the line item as an invoice item, a subsequent credit item, a subsequent debit item, a credit memo item, or any other suitable type of line item. In order to enable the user to enter or otherwise select such an item kind for a particular line item, the system may provide, for example, a mechanism on the interface for inputting invoice that allows the user to select or otherwise input an item kind for a line item of the invoice at stage 604. The user may select the item kind from a plurality of item kinds displayed, for example, in a drop down menu or any other suitable mechanism.

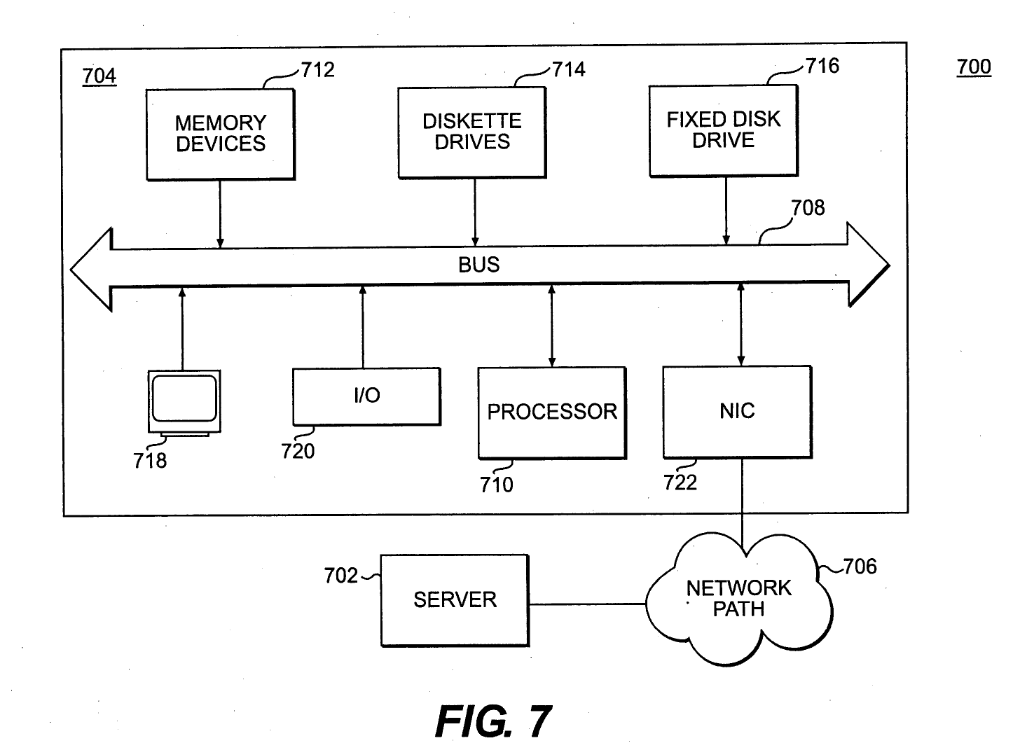

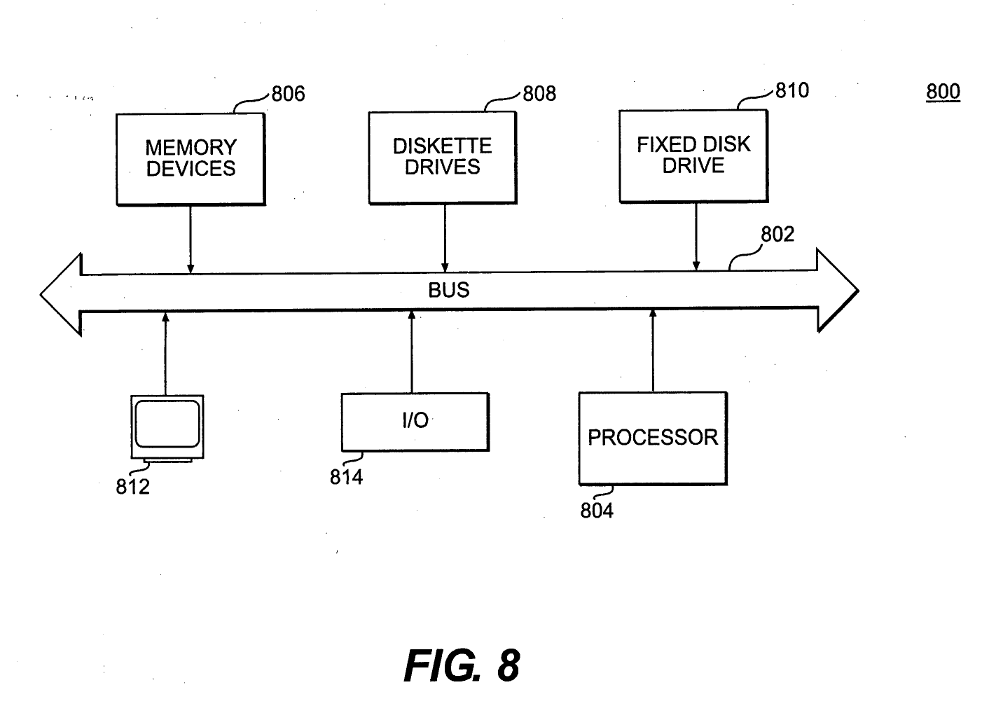

A computer system may be used to install a software application implementing a system and method for enabling the user to input, view, and interact with an invoice having one or more line items in accordance with a system consistent with the principles of the present invention. The computer system may be a computer network, as shown in FIG. 7, or a stand-alone personal computer (PC), as shown in FIG. 8.

As shown in FIG. 7, a computer network 700 in accordance with a system consistent with the principles of the present invention may include a server 702 and a stand-alone PC 704 connected through a network path 706. Computer network 700 may be a local area network (LAN), where server 702 and PC 704 are workstations. Computer network 700 may also be the Internet, with server 702 hosting a web application and PC 704 being any workstation available to a user desiring to interface with the application on server 602. Alternatively, computer network 700 may be a wide area network (WAN), and server 702 and PC 704 may lie in two separate LANs connected through the Internet.

PC 704 may include a bus line 708 connecting a plurality of devices such as a processor 710, memory devices 712 for storage of information, diskette drives 714, a fixed disk drive 716, a monitor or display 718, other I/O devices 720, and a network interface card (NIC) 722. Processor 710 may be a microprocessor such as an Intel Pentium™ chip for processing applications. Memory devices 712 may include read-only memories (ROM) and/or random access memories (RAM). Diskette drives 714 may include a floppy drive and/or a compact disk (CD) drive. Fixed disk drive 716 may be a hard drive. I/O devices 720 may include a keyboard and/or a mouse for receiving input from a user of PC 704. Monitor or display 718 may display output from processor 710, and may also echo the input of the user. PC 704 may be connected to network path 706 through NIC 722.

A web application may be installed on server 702. An individual desiring to enter data into the application on server 702 may use a web browser loaded on PC 704, and may communicate with server 702 through NIC 722 and network path 706. In one aspect, software application for implementing a system consistent with the principles of the present invention may be stored in PC 704 and processor 710 of PC 704 may execute the software application locally within PC 704 and interface with a web application on server 702. Particularly, the software application may be stored on a floppy disk, a CD, or any other suitable readable media, which may be accessible by diskette drive 714, fixed disk drive 716, or any other suitable mechanism. In another aspect, the software application for implementing a system consistent with the principles of the present invention may be stored in server 702, which may execute the software application, and processor 710 of PC 704 may communicate with server 702 to send information to server 702 and retrieve the results of the execution of the software application from server 702.

Through the execution of the software application implementing a system consistent with the principles of the present invention, either locally within PC 704 or remotely within server 702, an interface may be provided on a user display, which enables the user to input, view, and interact with an invoice having one or more line items of different line item types.

Alternatively, as shown in FIG. 8, a stand-alone PC 800 may be used for implementing a software application implementing a system consistent with the principles of the present invention. PC 800 may include a bus line 802 connecting a plurality of devices, which may include a processor 804, memory devices 806 for storage of information, diskette drives 808, a fixed disk drive 810, a monitor or display 812, and other I/O devices 814. Processor 804 may be a microprocessor such as an Intel Pentium™ chip for processing applications. Memory devices 806 may include ROM and/or RAM. Diskette drives 808 may include a floppy drive and/or a compact disk (CD) drive. Fixed disk drive 810 may be a hard drive. Monitor or display 812 may display the output of processor 804 and may also echo the input of the user. I/O devices 814 may include a keyboard and/or a mouse for receiving input from a user of PC 800.

A software application implementing a system consistent with the principles of the present invention may be stored on a floppy disk or a CD accessible by diskette drive 808 or on fixed disk drive 810. Processor 804 may execute the software application stored in the floppy disk the CD or the fixed disk drive 810. An individual, through monitor or display 812 and I/O devices 814, may interact with processor 804, which may execute the software application. A software application implementing a system consistent with the principles of the present invention may be written in any number of programming languages, including but not limited to JavaScript, Visual Basic, Flash, ABAP coding, or any other suitable language. Similarly, the present invention is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. Accordingly, embodiments of the invention are not limited to the above described embodiments and examples, but instead is defined by the appended claims in light of their full scope of equivalents.

1. A method for inputting an invoice into a computer system, the method comprising:
providing an interface on a display that allows a user to input an invoice, wherein the invoice includes one or more line items; and
providing on the interface a mechanism that allows the user to select an item kind attribute for at least one of the one or more line items from a plurality of item kind attributes, wherein the plurality of item kind attributes includes at least two of invoice, subsequent credit, subsequent debit, and credit memo.

2. The method of claim 1, wherein the mechanism that allows the user to select an item kind attribute is a drop down menu.

3. The method of claim 1, further comprising saving the invoice on the computer system.

4. The method of claim 3, further comprising:
determining that one of the one or more line items is associated with an item kind attribute that is one of subsequent credit, subsequent debit, or credit memo;
determining that the one of the one or more line items conflicts with its corresponding line item that is associated with an item kind attribute of invoice; and
preventing saving of the invoice on the computer system.

5. The method of claim 3, further comprising:
determining that a first one of the one or more invoice items is associated with an item kind attribute that is one of subsequent credit, subsequent debit, or credit memo;
identifying a second one of the one or more invoice items that correspond to the first one of the one or more invoice items, wherein the second one of the one or more invoice items is associated with an item kind attribute of invoice;
determining that an item quantity associated with the first one of the one or more invoice items is greater than an item quantity associated with the second one of the one or more invoice items; and
preventing saving of the invoice on the computer system.

6. A computer system for allowing user input of an invoice, the system comprising:
an I/O device;
a display; and
a processor configured to:
providing an interface on the display that allows a user to input an invoice using the I/O device, wherein the invoice includes one or more line items; and
providing on the interface a mechanism that allows the user to select an item kind attribute for at least one of the one or more line items from a plurality of item kind attributes, wherein the plurality of item kind attributes includes at least two of invoice, subsequent credit, subsequent debit, and credit memo.

7. The system of claim 6, wherein the mechanism that allows the user to select an item kind attribute is a drop down menu.

8. The system of claim 6, wherein the processor is further configured to saving the invoice on the computer system.

9. The system of claim 8, wherein the processor is further configured to:
determining that one of the one or more line items is associated with an item kind attribute that is one of subsequent credit, subsequent debit, or credit memo;
determining that the one of the one or more line items conflicts with its corresponding line item that is associated with an item kind attribute of invoice; and
preventing saving of the invoice on the computer system.

10. The system of claim 8, wherein the processor is further configured to:
determining that a first one of the one or more invoice items is associated with an item kind attribute that is one of subsequent credit, subsequent debit, or credit memo;
identifying a second one of the one or more invoice items that correspond to the first one of the one or more invoice items, wherein the second one of the one or more invoice items is associated with an item kind attribute of invoice;
determining that an item quantity associated with the first one of the one or more invoice items is greater than an item quantity associated with the second one of the one or more invoice items; and
preventing saving of the invoice on the computer system.

11. A computer-readable medium including instructions for performing, when executed by a processor, a method for inputting an invoice into a computer system, the method comprising:
providing an interface on a display that allows a user to input an invoice, wherein the invoice includes one or more line items; and
providing on the interface a mechanism that allows the user to select an item kind attribute for at least one of the one or more line items from a plurality of item kind attributes, wherein the plurality of item kind attributes includes at least two of invoice, subsequent credit, subsequent debit, and credit memo.

12. The computer-readable medium of claim 11, wherein the mechanism that allows the user to select an item kind attribute is a drop down menu.

13. The computer-readable medium of claim 11 further includes instructions for saving the invoice on the computer system.

14. The computer-readable medium of claim 13 further includes instructions for:
determining that one of the one or more line items is associated with an item kind attribute that is one of subsequent credit, subsequent debit, or credit memo;
determining that the one of the one or more line items conflicts with its corresponding line item that is associated with an item kind attribute of invoice; and
preventing saving of the invoice on the computer system.

15. The computer-readable medium of claim 13 further includes instructions for:
determining that a first one of the one or more invoice items is associated with an item kind attribute that is one of subsequent credit, subsequent debit, or credit memo;
identifying a second one of the one or more invoice items that correspond to the first one of the one or more invoice items, wherein the second one of the one or more invoice items is associated with an item kind attribute of invoice;
determining that an item quantity associated with the first one of the one or more invoice items is greater than an item quantity associated with the second one of the one or more invoice items; and
preventing saving of the invoice on the computer system.

16. A method for entering a credit memo associated with an invoice in a computer system, the method comprising:
identifying a relevant invoice associated with one or more invoice items in the computer system;
allowing entry of a credit memo having an item that corresponds with one or more invoice items of the invoice; and
comparing a quantity item associated with the credit memo item with one or more quantity items associated with the corresponding one or more invoice items to determine if the quantity item associated with the credit memo item exceeds a total of the quantity items associated with the corresponding one or more invoice items.

17. The method of claim 16, further comprising alerting a user if the quantity item associated with the credit memo item exceeds a total of the quantity items associated with the corresponding one or more invoice items.

18. The method of claim 17, further comprising preventing saving of the credit memo in the computer system.

19. The system of claim 6, wherein the processor is further configured to:
identify a relevant invoice associated with one or more invoice items in the computer system;
allow entry of a credit memo having an item that corresponds with one or more invoice items of the invoice; and
compare a quantity item associated with the credit memo item with one or more quantity items associated with the corresponding one or more invoice items to determine if the quantity item associated with the credit memo item exceeds a total of the quantity items associated with the corresponding one or more invoice items.

20. The system of claim 6, wherein the processor is further configured to:
perform at least one of alerting a user if the quantity item associated with the credit memo item exceeds a total of the quantity items associated with the corresponding one or more invoice items and preventing saving of the credit memo in the computer system.
